(19) United States
(12) Patent Application Publication
(10) Pub. No.: US 2005/0117211 A1
(43) Pub. Date: Jun. 2, 2005

(54) Method of marking a piece of material

(76) Inventor: John Stuart Cotterill, Somerset (GB)

Correspondence Address: PATTERSON, THUENTE, SKAAR & CHRISTENSEN, P.A., 4800 IDS CENTER, 80 SOUTH 8TH STREET, MINNEAPOLIS, MN, 55402-2100, US

(21) Appl. No.: 11/001,226

(22) Filed: Dec. 1, 2004

(30) Foreign Application Priority Data
Dec. 2, 2003 (GB) 0327925.4
Dec. 8, 2003 (EP) 03257700.9

(51) Int. Cl. G02B 27/02; G06K 7/10

(52) U.S. Cl. 359/442

(57) ABSTRACT

A method of marking a piece of material with information by loading an apparatus with both the information and a mirror image of the information and marking the piece of material, in accordance with both the information and the mirror image of the information, by causing the apparatus to project the light beam on to the piece of material which is sensitive to the light.

### BACKGROUND OF THE INVENTION

The invention relates to a method of marking a piece of material by means of an apparatus which, in operation, is loaded with information in electronic form and is operable to mark the piece of material in accordance with the loaded information.

An ink-jet printing or marking apparatus may be so controlled as to effect marking of the piece of material or the apparatus may be such as to project a light beam on to the piece of material under the control of the information in electronic form.

The marking of the outer insulating material of a cable may be effected by the use of ultra-violet (UV) laser cable-marking apparatus, causing controlled selective darkening at the surface of the material where struck by UV light from the UV laser cable-marking apparatus. The darkening is a result of a photo-chemical reaction of the insulating material, usually polytetrafluoroethylene (PTFE) or ethylene tetrafluoroethylene (ETFE), to the UV light. Alternatively, the marking of the outer insulating material of a cable may be effected by the use of ink-jet printing to deposit ink on the cable surface.

### SUMMARY OF THE INVENTION

The invention provides a method of marking a piece of material by means of an apparatus which, in operation, is loaded with information in electronic form and is operable to mark the material in accordance with the loaded information, including the step of loading the apparatus with both the information and a mirror image of the information and marking the piece of material, in accordance with both the information and the mirror image of the information.

One form of the invention provides a method of marking a piece of material by means of an apparatus which is operable to project a light beam on to a piece of material which is sensitive to the light and, thereby, to mark the material in accordance with the loaded information, including the step of loading the apparatus with both the information and a mirror image of the information and marking the piece of material, in accordance with both the information and the mirror image of the information, by causing the apparatus to project the light beam on to the piece of material.

An alternative form of the invention provides a method of marking a piece of material by means of an apparatus which includes ink-jet marking means, including the step of causing the deposition of ink on the piece of material in accordance with both the information and a mirror image of the information.

Preferably, in the execution of the method using ink-jet marking apparatus, the deposited ink is cured by subjecting it to UV light.

The method may be employed on a length of material, including the step of marking the length of material, in accordance with the information and the mirror image of the information, by causing the projection of a beam of light on to the length of material.

The method may be employed on a length of material, including the step of marking the length of material, in accordance with the information and the mirror image of the information, by causing the deposition of ink on the length of material.

The method may be employed on a length of the outer material of a cable, including the step of marking the length of outer material, in accordance with the information and the mirror image of the information, by causing the projection of a beam of light on to the length of outer material.

The method may be employed on a length of the outer material of a cable, including the step of marking the length of outer material, in accordance with the information and the mirror image of the information, by causing the deposition of ink on the length of outer material.

The method may be employed on a piece of material that is a tape that is contained between a cable core and a partially transparent sleeve running lengthways to the cable, the tape being so positioned as to be visible through the partially transparent sleeve, allowing information on the tape to be read through the partially transparent sleeve, including the step of marking the tape, in accordance with the information and the mirror-image of the information, by causing either the projection of a light beam or the deposition of ink on the tape, prior to the tape being assembled in the cable.

The exercise of the method provides a piece of material including information and a mirror-image of the information, wherein the information and the mirror-image information are a product of the method.

The exercise of the method also provides a length of cable including information and a mirror-image of the information, wherein the information and the mirror-image information are a product of the method.

More generally, there are provided a piece of material and a length of cable including information and a mirror-image of the information visible at the exterior of, respectively, the piece of material and the length of cable.

The invention also provides an apparatus which is loaded with information in electronic form and is operable to control means of marking a workpiece, for marking a piece of material in accordance with the loaded information, wherein the apparatus is loaded with both the information and a mirror image of the information and is operable to provide the loaded information as an output signal.

The practice of the method is especially suited to the aerospace industry, providing an engineer with a means of quickly identifying a cable in a relatively inaccessible location by use of a reflective surface such as an inspection mirror, and serves to reduce the requirement for intrusive inspection of a cable bundle for the purpose of cable identification and, further, serves to reduce the time involved in identifying a cable in a relatively inaccessible location. As is indicated above, UV laser marking may be used or, alternatively, ink-jet marking may be applicable.

The method may be implemented on any cable that a laser-marking machine is capable of marking. Cables that may be marked by the method range in size from 26 AWG (0.75 mm outside diameter) up to 8 AWG (6.2 mm outside diameter). The font size for the identification information is typically 1.2 mm or 1.4 mm vertical lettering (characters one above another) for cable diameters of 0.75 mm to 1.62 mm and 1.2 mm horizontal lettering (characters side by side) for cable diameters of 1.45 to 6.2 mm.

The method is especially suitable for use in the aerospace industry, particularly on cables employed in that industry but may be used in any activity in which there may be a need to identify an item or items in relatively inaccessible locations.

A method of marking a piece of material in accordance with the invention will now be described, by way of example only, with reference to the accompanying drawings.

### DESCRIPTION OF THE FIGURES

FIG. 1 is a block diagram representation of a UV laser cable-marking apparatus, including UV laser writing equipment and control means, used in performing the method of marking a piece of material,

FIG. 2 shows a first length of electrical cable including outer insulating material bearing information resulting from the execution of the method on the first length of cable,

FIG. 3 shows a second length of electrical cable including outer insulating material bearing information resulting from the execution of the method on the second length of cable, and

FIG. 4 is a diagrammatic representation of an ink-jet delivery means which may be used as an alternative to the UV laser writing equipment of the UV laser cable-marking apparatus, in the method of marking a piece of material.

### DETAILED DESCRIPTION OF THE PREFERRED EMBODIMENTS

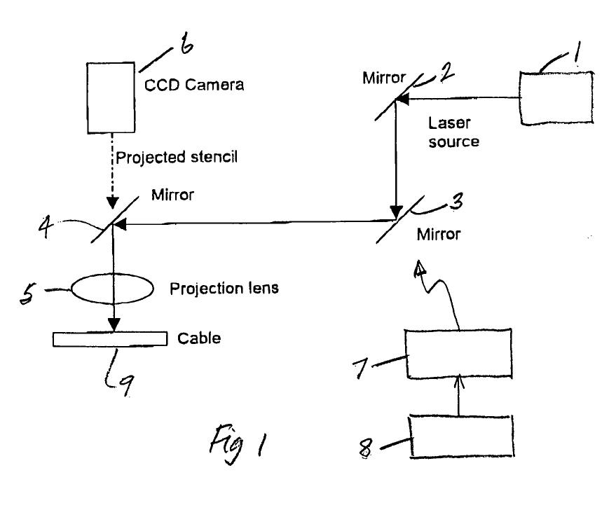

Referring to FIG. 1 of the accompanying drawings, a UV laser cable-marking apparatus is represented by UV laser writing equipment including a UV laser source 1, a first mirror 2, a second mirror 3, a third mirror 4, a lens 5, a charge-coupled-device (CCD) camera 6, and control means including an interface circuit 7 and a keyboard 8. A cable 9 is shown so positioned as to receive light focussed by the lens 5.

The mirrors 2, 3 and 4 are so positioned relative to the UV laser source 1 as to guide UV laser light from the UV laser source 1 to the lens 5 which focusses the UV laser light on to the cable 9. The CCD camera 6 functions to generate and project an image, which serves as a stencil, on to the surface of the material to be marked. The image generated and projected by the CCD camera 6 is provided in electronic form by the interface circuit 7 which is controlled through the keyboard 8.

In the practice of the method, the CCD camera 6, through the keyboard 8 and the interface circuit 7, is used to generate and project normal and mirror-image blocks of cable identification information. The information is written on the outer covering of the cable 9 as a result of controlled selective darkening at the surface of the material where struck by UV laser light from the UV laser source 1.

The method is put into practice by the appropriate modification of the control software of UV laser cable-marking apparatus used in writing normal blocks of identification information on cables.

The interface circuit 7, which may include a an electrical processing circuit, for example, a central processing unit (CPU), is loaded with and stores the normal and mirror-image blocks of information. The interface circuit 7 may be capable of serving as a controller to equipment other than UV laser writing equipment as represented by the components 1 to 6 in FIG. 1. It follows that the interface circuit 7 is an apparatus which is loaded with both information and a mirror-image of the information in electronic form and may be used to control any one of a plurality of means of marking a workpiece, providing the loaded information as an output signal. Suitable means for marking a workpiece include, of course, an ink-jet delivery means and UV laser writing equipment.

The block of identification information may be written on the outer covering material of the cable 9.

Alternatively, the cable may include a tape that is contained between the cable core and a partially transparent sleeve running lengthways to the cable, the tape being so positioned as to be visible through the partially transparent sleeve, allowing information on the tape to be read through the partially transparent sleeve. In a cable including a tape visible through a partially transparent sleeve, the block of cable identification information may be added by causing the projection of a light beam or the deposition of ink on to the tape, prior to the tape being assembled in the cable.

The inclusion of both mirror-image blocks in addition to normal blocks of identification information on lengths of cable significantly improves the chances of correctly identifying cables in relatively inaccessible places, by the use of an inspection mirror, the mirror-image blocks of identification information being legible whereas the normal blocks are somewhat less legible, when viewed as a mirror image.

When a cable including normal and mirror-image blocks of identification information forms one of a bundle of cables in a cable harness, say, the problem of identifying specific cables routed in relatively inaccessible places is reduced by the presence of the mirror-image blocks of identification information, alternating with the normal blocks of identification information along the cable, allowing an engineering maintainer to read the blocks of mirror-image information using an inspection mirror and the normal blocks in the normal manner.

Also, the inclusion of both mirror-image blocks in addition to normal blocks of identification information on lengths of cable significantly reduces the number of occasions on which it becomes necessary to remove cable retainers and open out a cable bundle in order to identify a cable that is relatively inaccessible. Since the operation of removing cable retainers from a cable bundle and opening it out must, in due course, be reversed, there is a time penalty involved when such action is needed and, also, a probability that a cable or cables may suffer damage. A reduction in the number of instances when cable bundles need to be opened out saves time, therefore, and reduces the probability of damage to a cable or cables during maintenance and fault-finding.

Referring to FIG. 2 of the accompanying drawings, a first length of electrical cable includes an outer cover 100 of insulating material bearing first, second and third blocks of information 101, 102 and 103 which lie along the cable and are so spaced apart as to make them identifiable as separate blocks. The characters making up the blocks include alpha-numeric characters and are set side by side along the cable.

The first and third blocks of information 101 and 103, as shown in FIG. 2, are the same as each other. Fifth, seventh and all other odd-numbered blocks, which would be accommodated on a longer piece of cable, are also the same as one another and are not shown in FIG. 2. The first, third and the other odd-numbered blocks of information are presented in the normal form of presentation of characters and are legible from left to right as viewed in the drawing.

The second and other even-numbered blocks of information, of which only the second block is shown in FIG. 2, are the same as one another and are, in fact, a mirror image of the odd-numbered blocks as viewed in the drawing. The mirror-image blocks are legible in the normal form of presentation of characters when viewed in a mirror held either below the cable, as viewed in the drawing, or orthogonal to the length of cable at a position between adjacent blocks of information.

The blocks of information on the outer cover 100 of the first length of electrical cable result from the execution of the method on the first length of cable by the use of the UV laser cable-marking apparatus of FIG. 1.

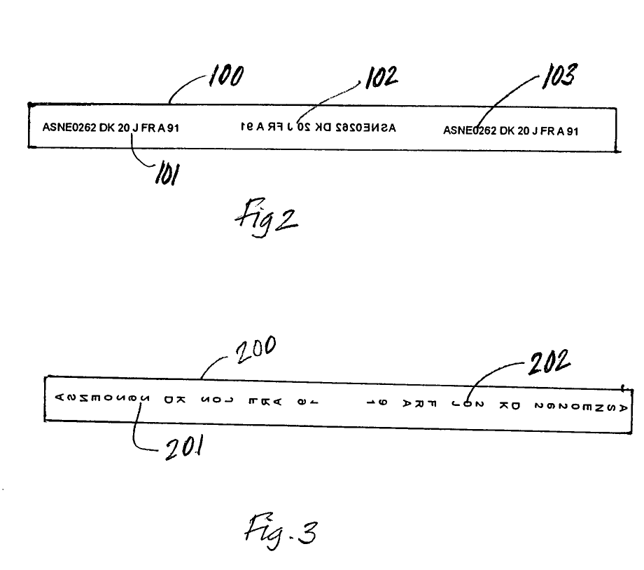

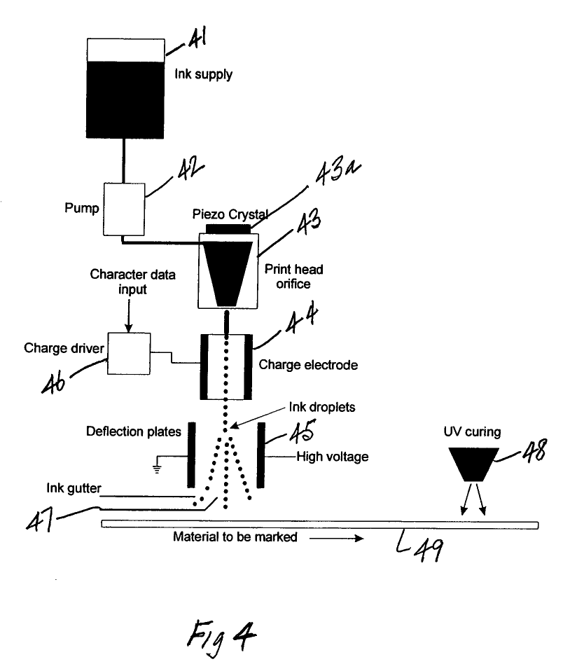

Referring to FIG. 3 of the accompanying drawings, a second length of electrical cable includes an outer cover 200 of insulating material bearing first and second blocks of information 201 and 202, which lie along the cable and are so spaced apart as to make them identifiable as separate blocks. The characters making up the blocks include alpha-numeric characters and are set one above another along the cable. The first block is a mirror image of the second block, as viewed in the drawing, and is legible in the normal form of presentation of characters, when viewed in a mirror held either above or below the cable or orthogonal to the length of cable at a position between the blocks.

The situation being similar to that for FIG. 1, the blocks of information on the outer cover 200 of the second length of cable result from the execution of the method on the second length of cable by the use of the UV laser cable-marking apparatus of FIG. 1

There are forms of cable, which are alternatives to those shown in FIGS. 2 and 3, including a tape that is contained between the cable core and a partially transparent sleeve running lengthways to the cable, the tape being so positioned as to be visible through the partially transparent sleeve, allowing information on the tape to be read through the partially transparent sleeve. The information on the tape may be arranged in blocks similar to those used in either FIG. 2 or FIG. 3 and may be added by the use of the UV laser cable-marking apparatus of FIG. 1, the tape being marked prior to its assembly in the cable.

An alternative to the UV laser cable-marking apparatus is an ink-jet marking apparatus which, in this case, becomes a cable-marking apparatus.

Referring to FIG. 4 of the accompanying drawings, an ink-jet delivery means includes an ink supply tank 41 for holding an ink supply, a pressure pump 42, a print head 43 with an associated piezo-electric crystal oscillator 43a, a charging electrode arrangement 44, a set of high-voltage deflection plates 45, a charge driver 46, an ink gutter 47 and a source of UV light 48, serving to cure the ink deposited on a piece of material 49. The addition of control means including an interface circuit and a keyboard corresponding to the interface circuit 7 and the keyboard 8 of FIG. 1 provides an ink-jet marking apparatus. The interface circuit and keyboard are not shown in FIG. 4.

In the operation of the ink-jet marking apparatus, ink is fed from the ink supply tank 41 via the pressure pump 42 into the print head 43. The ink flow is regulated by the action of the piezo-electric crystal oscillator 43a. The ink breaks down into droplets which leave the print head 43 from an orifice and is then passed through the charging electrode arrangement 44. Character data, which is provided by the interface circuit and keyboard, is provided as an input to the charge driver 46 which drives the charge electrode arrangement 44, effecting the charging of the ink droplets. The ink droplets are then directed through the electrostatic field generated by the set of high voltage deflector plates 45. The charged droplets are deflected by the electrostatic field, in accordance with the character data, onto the surface of the piece of material 49 being marked. Stray droplets are collected by the ink gutter 47 and returned to the ink tank. The ink deposited as characters on the piece of material 49 is cured by means of the source of UV light 48 to provide protection and durability.

Lengths of electrical cable that include material bearing information resulting from the execution of the method on the lengths of cable, may be included in a cable harness or other form of cable bundle to which are usually applied cable ties, or the like, which resist or even prevent the separation of one or more cables from the harness or bundle. A cable harness or bundle may be routed throughout the airframe of an aircraft, making at least some parts of the cable harness or bundle relatively inaccessible. A similar situation may exist in relation to other vehicles or to installations which include electrical wiring.

The information on a length of cable resulting from the execution of the method on the length of cable, may serve as system and circuit identification information, indicating the type and size of the cable and the system and circuit to which it belongs, especially when the length of cable belongs to a cable harness or bundle routed throughout a vehicle or an aircraft.

The inclusion of system and circuit identification information on a length of cable is usually essential for maintenance and fault-finding purposes, the blocks of identification information being positioned with regular spacing along the cable. A maximum spacing of 75 mm between adjacent blocks of identification information is usual for the established arrangement in which there are no mirror-image blocks and the addition of mirror-image blocks alternating with normal blocks, as shown in FIGS. 2 and 3, provides arrangements with a maximum spacing of 75 mm between adjacent blocks of identification information.

The method has been described with reference to the marking of an electrical cable, but is equally applicable to the marking of a fibre-optic cable.

Laser-marking is most commonly performed using a UV laser but it will be appreciated that lasers in other frequency ranges may be used where the light frequency and materials involved are such that selective permanent marking is possible.

Ink-jet marking would, of course, be applicable where the material to be marked is not sensitive to light but could be used even if the material is sensitive to light.

1. A method of marking a piece of material by means of an apparatus which, in operation, is loaded with information in electronic form and is operable to mark the material in accordance with the loaded information, the method comprising the steps of loading the apparatus with both the information and a mirror image of the information and marking the piece of material, in accordance with both the information and the mirror image of the information.

2. A method of marking a piece of material as claimed in claim 1, by means of an apparatus which is operable to project a light beam on to a piece of material which is sensitive to the light and, thereby, to mark the material in accordance with the loaded information, the method comprising the step of loading the apparatus with both the information and a mirror image of the information and marking the piece of material, in accordance with both the information and the mirror image of the information, by causing the apparatus to project the light beam on to the piece of material.

3. A method of marking a piece of material as claimed in claim 1, by means of an apparatus including ink-jet marking means, the method further comprising the step of causing the deposition of ink on the piece of material in accordance with both the information and a mirror image of the information.

4. A method as claimed in claim 3, further comprising the step of curing the deposited ink by subjecting it to UV light.

5. A method as claimed in claim 3, wherein the piece of material is a length of material, the method further comprising the step of marking the length of material, in accordance with the information and the mirror image of the information, by causing the deposition of ink on the length of material.

6. A method as claimed in claim 2, wherein the piece of material is a length of material, the method further comprising the step of marking the length of material, in accordance with the information and the mirror image of the information, by causing the projection of a light beam on to the length of material.

7. A method as claimed in claim 3, wherein the piece of material is a length of the outer material of a cable, the method further comprising the step of marking the length of outer material, in accordance with the information and the mirror image of the information, by causing the deposition of ink on the length of outer material.

8. A method as claimed in claim 2, wherein the piece of material is a length of the outer material of a cable, the method further comprising the step of marking the length of outer material, in accordance with the information and the mirror image of the information, by causing the projection of a light beam on to the length of outer material.

9. A method as claimed in claim 2, wherein the piece of material is a tape that is contained between a cable core and a partially transparent sleeve running lengthways to the cable, the tape being so positioned as to be visible through the partially transparent sleeve, allowing information on the tape to be read through the partially transparent sleeve, the method further comprising the step of marking the tape, in accordance with the information and the mirror-image of the information, by causing the projection of a light beam on to the tape, prior to its assembly in the cable.

10. A method as claimed in claim 3, wherein the piece of material is a tape that is contained between a cable core and a partially transparent sleeve running lengthways to the cable, the tape being so positioned as to be visible through the partially transparent sleeve, allowing information on the tape to be read through the partially transparent sleeve, the method further comprising the step of marking the tape, in accordance with the information and the mirror-image of the information, by causing the deposition of ink on the tape, prior to its assembly in the cable.

11. A piece of material comprising information and a mirror-image of the information, wherein the information and the mirror-image information are a product of a method as claimed in claim 1.

12. A piece of material comprising information and a mirror-image of the information, wherein the information and the mirror-image information are a product of a method as claimed in claim 2.

13. A piece of material comprising information and a mirror-image of the information, wherein the information and the mirror-image information are a product of a method as claimed in claim 3.

14. A length of cable comprising information and a mirror-image of the information, wherein the information and the mirror-image information are a product of a method as claimed in claim 1.

15. A length of cable comprising information and a mirror-image of the information, wherein the information and the mirror-image information are a product of a method as claimed in claim 2.

16. A length of cable comprising information and a mirror-image of the information, wherein the information and the mirror-image information are a product of a method as claimed in claim 3.

17. A piece of material comprising information and a mirror-image of the information visible at the exterior of the piece of material.

18. A length of cable comprising information and a mirror-image of the information visible at the exterior of the length of cable.

19. An apparatus which is loaded with information in electronic form and is operable to control means of marking a work-piece, for marking a piece of material in accordance with the loaded information, wherein the apparatus is loaded with both the information and a mirror image of the information and is operable to provide the loaded information as an output signal.
